(19) United States
(12) Patent Application Publication
(10) Pub. No.: US 2006/0017328 A1
(43) Pub. Date: Jan. 26, 2006

(54) Control system for distributed power generation, conversion, and storage system

(76) Inventor: Jan Henrik Bryde, Drammen (NO)

Correspondence Address: Brian M. Berliner;O'MELVENY & MYERS LLP, 400 South Hope Street, Los Angeles, CA, 90017-2899, US

(21) Appl. No.: 11/106,925

(22) Filed: Apr. 14, 2005

Related U.S. Application Data
(63) Continuation-in-part of application No. 10/361,400, filed on Feb. 10, 2003.

(51) Int. Cl. H02J 9/00

(52) U.S. Cl. 307/64

(57) ABSTRACT

A distributed power generating system enables very rapid and reliable start-up of an engine used to generate back-up power, thereby substantially reducing the need for stored power. More particularly, the distributed power generating system comprises a power bus electrically coupled to commercial power and to a load, an engine comprising a rotatable shaft, a starter/generator operatively coupled to the shaft of the engine and electrically coupled to the power bus, and a temporary storage device electrically coupled to the power bus. The distributed power generating system further comprises a control system adapted to detect a failure of the commercial power and cause the starter/generator to start the engine from a standstill condition. The control system provides the starter/generator with an initial voltage vector selected to rapidly bring the engine to an operational speed sustainable by the engine alone. The temporary storage device supplies electrical power to the power bus for delivery to the load and for powering the starter/generator until the engine reaches the operational speed, whereupon the control system causes the starter/generator to take over supply of electrical power to the power bus for delivery to the load. The control system starts the engine upon detection of a voltage on the power bus below a predetermined lower limit. After the engine has started, the control system monitors speed of the engine to determine whether the operational speed is reached. The control system terminates operation of the engine upon detection of a voltage on the power bus above a predetermined upper limit.

### RELATED APPLICATION DATA

This is a continuation-in-part of co-pending patent application Ser. No. 10/361,400, for DISTRIBUTED POWER GENERATION, CONVERSION, AND STORAGE SYSTEM, filed Feb. 10, 2003.

### BACKGROUND OF THE INVENTION

1. Field of the Invention

The present invention pertains to the generation of electrical power. In particular, this invention relates to a control system for distributed power generation systems used close to where electricity is used (e.g., a home or business) to provide an alternative to or an enhancement of the traditional electric power system.

2. Description of Related Art

Centralized electric power generating plants provide the primary source of electric power supply for most commercial, agricultural and residential customers throughout the world. These centralized power-generating plants typically utilize an electrical generator to produce electrical power. The generator has an armature that is driven by conversion of an energy source to kinetic energy, such as a water wheel in a hydroelectric dam, a diesel engine or a gas turbine. In most cases, steam is used to turn the armature, and the steam is created either by burning fossil fuels (e.g., oil, coal, natural gas, etc.) or through nuclear reaction. The generated electrical power is then delivered over a grid to customers that may be located great distances from the power generating plants. Due to the high cost of building and operating electric power generating plants and their associated power grid, most electrical power is produced by large electric utilities that control distribution for defined geographical areas.

In recent years, however, there has been a trend away from the centralized model of electric power generation toward a distributed power generation model. One reason for this trend is the inadequacy of the existing electric power infrastructure to keep pace with soaring demand for high-quality, reliable power. Electric power distributed in the traditional, centralized manner tends to experience undesirable frequency variations, voltage transients, surges, dips or other disruptions due to changing load conditions, faulty or aging equipment, and other environmental factors. This electric power is inadequate for many customers that require a premium source of power (high quality) due to the sensitivity of their equipment (e.g., computing or telecommunications providers) or that require high reliability without disruption (e.g., hospitals). The utilities that traditionally operate centralized power generating plants are increasingly reluctant to make the large investments in modernized facilities and distribution equipment needed to improve the quality and reliability of their electric power due to regulatory, environmental, and political considerations.

More recently, technological advancements in small-scale power generating equipment has led to greater efficiencies, environmental advantages, and lower costs for distributed power generation. Various technologies are available for distributed power generation, including turbine generators, internal combustion engine/generators, microturbines, photovoltaic/solar panels, wind turbines, and fuel cells. Distributed power generating systems can complement centralized power generation by providing incremental capacity to the utility grid or to an end user. By installing a distributed power generating system at or near the end user, the electric utility can also benefit by avoiding or reducing the cost of transmission and distribution system upgrades. For the end user, the potential lower cost, higher service reliability, high power quality, increased energy efficiency, and energy independence are all reasons for interest in distributed power generating systems.

There are numerous applications for distributed power generating systems. A primary application is to produce premium electric power having reduced frequency variations, voltage transients, surges, dips or other disruptions. Another application is to provide standby power (also known as an uninterruptible power supply or UPS) used in the event of a power outage from the electric grid. Distributed power generating systems can also provide peak shaving, i.e., the use of distributed power during times when electric use and demand charges are high. In such cases, distributed power can be used as baseload or primary power when it is less expensive to produce locally than to purchase from the electric utility. By using the waste heat for existing thermal processes, known as co-generation, the end user can further increase the efficiency of distributed power generation.

Not withstanding these and other advantages of distributed power generation, there are other disadvantages that must be overcome to achieve wider acceptance of the technology. Conventional distributed power generating systems require further improvements in reliability and efficiency in order to compete effectively with centralized power generation. Distributed power generating systems that utilize an engine to drive a generator tend to be slow to achieve an operational speed from start up, and consequently are slow to provide a source of back-up power. During the time necessary to bring the engine and generator up to operational speed, the distributed power generating system must rely on stored power (i.e., batteries) to supply the back-up source. Battery storage systems are large, expensive, heavy, and have relatively short life expectancy. It is therefore desirable to minimize reliance of the distributed power generating system on batteries.

Accordingly, it would be desirable to provide a distributed power generating system to serve as an alternative to or enhancement of centralized power generation that overcomes these and other drawbacks of conventional distributed power generation. More particularly, it would be desirable to provide a control system for a distributed power generating system that brings the power generating system to an operational state very rapidly so as to reduce the reliance on stored power.

### SUMMARY OF THE INVENTION

The present invention is directed to a distributed power generating system that enables very rapid and reliable start-up of the engine used to generate back-up power, thereby substantially reducing the need for stored power. The distributed power generating system does not include many of the mechanical components of conventional power generating systems, such as the mechanical switchgear, starter motor and associated linkage, which represent significant failure points of the conventional systems. As a result, the present invention provides a highly reliable and cost effective distributed power generating system.

More particularly, the distributed power generating system comprises a power bus electrically coupled to commercial power and to a load, an engine comprising a rotatable shaft, a starter/generator operatively coupled to the shaft of the engine and electrically coupled to the power bus, and a temporary storage device electrically coupled to the power bus. The starter/generator is adapted to start the engine from a standstill condition and rapidly brings the engine to an operational speed sustainable by the engine alone. To accomplish this, the starter/generator has a short time torque capability higher than the rated torque of the engine and starter/generator. When the engine reaches the operational speed, the starter/generator delivers electrical power to the power bus. Upon a fault of the commercial power, the temporary storage device supplies electrical power to the power bus for delivery to the load and for powering the starter/generator until the engine reaches the operational speed, whereupon the starter/generator takes over supply of electrical power to the power bus for delivery to the load.

In an embodiment of the invention, the distributed power generating system further comprises a control system adapted to detect a failure of the commercial power and cause the starter/generator to start the engine from a standstill condition. The control system provides the starter/generator with an initial voltage vector selected to rapidly bring the engine to an operational speed sustainable by the engine alone. The temporary storage device supplies electrical power to the power bus for delivery to the load and for powering the starter/generator until the engine reaches the operational speed, whereupon the control system causes the starter/generator to take over supply of electrical power to the power bus for delivery to the load. The starter/generator further comprises a rotor and a stator, with the stator including a plurality of phase windings. The control system starts the engine upon detection of a voltage on the power bus below a predetermined lower limit. After the engine has started, the control system monitors speed of the engine to determine whether the operational speed is reached. The control system terminates operation of the engine upon detection of a voltage on the power bus above a predetermined upper limit.

More particularly, the control system identifies an initial position of the rotor relative to the stator and selects the voltage vector based on the initial position to provide maximum torque to the rotor. The control system first measures the self-inductance of said phase winding of the stator. Then, the control system estimates an angle of self-inductance of the stator based on the self-inductance of each phase winding in accordance with the following equation:

$$2 θ = - {tan}^{- 1} ( \frac{\frac{\sqrt{3}}{2} Δ {t}_{b} - \frac{\sqrt{3}}{2} Δ {t}_{c}}{Δ {t}_{a} - \frac{1}{2} Δ {t}_{b} - \frac{1}{2} Δ {t}_{c}} )$$

wherein, θ is the estimated angle of self-inductance of the stator, Δtₐ is the time for current in phase A of the stator to fall from a positive selected level to a negative selected level, Δt_{b} is the time for current in phase B of the stator to fall from the positive selected level to the negative selected level, and Δt_{c} is the time for current in phase C of the stator to fall from the positive selected level to the negative selected level. Thereafter, the control system tests the estimated angle of self-inductance of the stator to determine if it is accurate or off by 180°.

A more complete understanding of the control system for a distributed power generating system will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is a block diagram of a conventional distributed power generating system;

FIG. 2 is a block diagram of a distributed power generating system in accordance with an embodiment of the invention;

FIG. 3a is a block diagram showing the flow of power in the distributed power generating system prior to start up;

FIG. 3b is a block diagram showing the flow of power in the distributed power generating system during a first interval following start up;

FIG. 3c is a block diagram showing the flow of power in the distributed power generating system during a second interval following start up;

FIG. 4 is a block diagram of an exemplary control system for the distributed power generating system;

FIG. 5 is a flow diagram depicting operation of the distributed power generating system;

FIG. 6 is an electrical schematic diagram showing a rotor of a generator of the distributed power generating system; and

FIG. 7 is a flow diagram depicting an algorithm for identifying initial position of the rotor of the starter/generator.

### DETAILED DESCRIPTION OF THE PREFERRED EMBODIMENT

The present invention satisfies the need for a distributed power generating system to serve as an alternative to or enhancement of centralized power generation. Specifically, the present invention provides a distributed power generating system that achieves an operational state very rapidly so as to reduce the reliance on stored power. In the detailed description that follows, like element numerals are used to describe like elements illustrated in one or more of the figures.

FIG. 1 illustrates a block diagram of a conventional distributed power generating system 10. The distributed power generating system 10 includes switchgear 22 that enables the coupling of AC power to a load 24 from a variety of sources. Under normal conditions, AC power is delivered to the load 24 through the switchgear 22 from the AC power mains connected to the commercial power grid. In the event of a fault of the AC mains, the switchgear 22 cuts off the AC mains and delivers AC power to the load from either a generator 14 or a battery bank 28. The switchgear 22 can also supply the AC output of the generator 14 back to the power grid. The switchgear 22 may comprise a mechanical switch that is manually actuated by an operator or may be adapted to automatically actuate the switch upon detection of a fault.

The power generating system 10 further includes an engine 12 that drives the generator 14. The engine 12 may comprise a reciprocating engine using a combustible fuel such as propane, diesel or gasoline. The generator 14 converts the rotational energy of a rotor shaft driven by the engine 12 into AC power. The generator 14 is electrically connected to a rectifier 16 that converts the AC power into DC. The rectifier 16 is further electrically coupled to an inverter 18 that converts the DC power back into an AC output, such as a high voltage, three-phase AC output (e.g., 400/480 volts AC), that is delivered to the load 24 through the switchgear 22. Alternatively, the generator 14 may deliver AC power directly to the switchgear 22 without the intervening rectifier 16 and inverter 18, but it is advantageous to include the rectifier 16 and inverter 18 in order to regulate the frequency, phase and/or amplitude of the AC power delivered to the load 24.

A starter motor 32 connected to the engine 12 by an associated mechanical linkage 34 is used to start the engine 12 from a cold condition. The mechanical linkage 34 enables the starter motor 32 to be disengaged from the engine 12 once the engine has started. A battery 36 provides DC power to the starter motor 32. The battery bank 28 comprises a plurality of batteries (e.g., lead-acid batteries) that are coupled together in parallel to provide a source of DC power. The DC power is converted to AC power by inverter 26, which is in turn delivered to the switchgear 22 for delivery to the load 24. Rectified AC passing through the switchgear 22 from either the generator 14 or the AC mains may be used to charge the battery bank 28.

Upon the detection of a fault with the AC mains, the distributed power generating system 10 goes into the back up mode. The switchgear 22 first connects the battery bank 28 to the load 24 as discussed above to continue to supply AC power to the load. Meanwhile, the engine 12 is started by operation of the starter motor 32. Particularly, the starter motor 32 turns the shaft of the engine 12 at a minimal rate sufficient to begin a reciprocating cycle of the engine 12 (e.g., 500 rpm). When fuel within the cylinders of the engine 12 begins to ignite and the shaft of the engine is able to turn on its own, the starter motor 32 disengages from the engine 12. Eventually, the engine 12 reaches an operational speed (e.g., 3,000 rpm) and the generator 14 begins producing reliable AC power. The switchgear 22 then disconnects the battery bank 28 from the load 24 and connects the generator 14 to the load 24.

As discussed above, there are a number of significant drawbacks with the conventional distributed power generating system 10. First, there are a high number of components, including various mechanical components that are subject to failure. The mechanical switchgear 22 represents a particularly critical component, the failure of which can totally disable the power generating system 10 and further cause the failure of other system components. The mechanical linkage 34 also represents a critical failure point, since the engine 12 cannot be started if there is a failure of the linkage. Second, the engine 12 has a relatively long start-up time due to the use of a small capacity starter motor 32. Since the starter motor 32 is only used to turn over the engine 12 at a minimal rate sufficient to initiate internal combustion, it is known to use a low torque starter motor. If the engine 12 has been sitting idle for a while, it may take several seconds for the engine 12 to start. The battery bank 26 must therefore have sufficient capacity (and hence size) to supply the load 24 during the relatively long start-up time of the engine 12. Batteries have relatively limited life expectancies (e.g., approximately five years) and require routine maintenance to keep them in serviceable condition. Moreover, the battery bank 26 is used only for supplying the load 24 and not for powering the starter motor 32. The separate battery 36 used to power the starter motor 32 is susceptible to discharge, representing yet another critical failure point of the system 10.

The present invention overcomes these and other drawbacks of conventional distributed power generating systems. Particularly, the present invention enables very rapid and reliable start-up of the engine used to generate back-up power, thereby eliminating altogether the need for a battery bank. Moreover, the present invention does not include many of the mechanical components of conventional power generating systems, such as the mechanical switchgear, starter motor and associated linkage, which represent significant failure points of the conventional systems. As a result, the present invention provides a highly reliable and cost effective distributed power generating system.

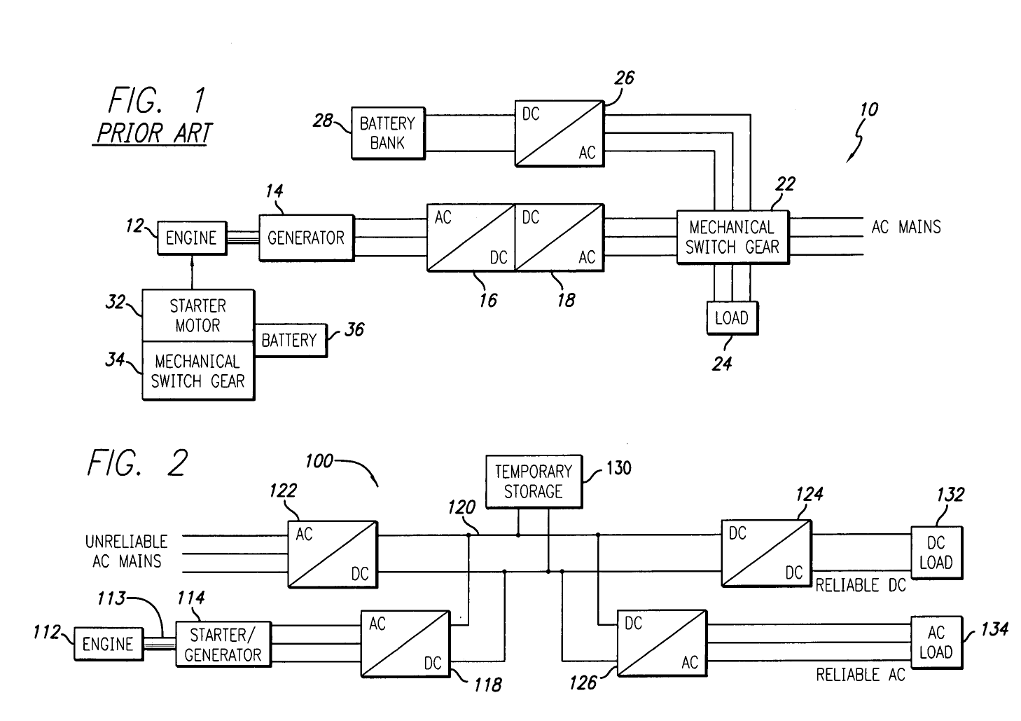

Referring now to FIG. 2, a power generating system 100 is illustrated in accordance with an embodiment of the invention. The power generating system 100 includes an engine 112 and a starter/generator 114. The engine 112 may be provided by a reciprocating internal combustion engine using a fuel such as propane, diesel or gasoline, although other types of engines such as turbines could also be advantageously utilized. The engine 112 drives a rotatable shaft 113 that is operatively coupled to the starter/generator 114. Unlike the conventional systems, the starter/generator 114 provides the dual functions of starting the engine 112 from a standstill condition and producing electrical power after the engine 112 reaches an optimum operational speed, thereby eliminating the need for a separate starter motor, linkage or battery.

Further, the present power generating system 100 avoids the use of mechanical switchgear by including a common DC power bus 120. DC power is supplied to the DC power bus 120 by the AC mains, the starter/generator 114, and a temporary storage 130. Rectifier 122 is electrically connected to the AC mains and delivers rectified DC power onto the common DC power bus 120. The starter/generator 114 is electrically connected to rectifier 118 that converts AC power produced by the starter/generator 114 into DC power that is provided to the common DC power bus 120. The temporary storage 130 provides short term or transient power. In an embodiment of the invention, the temporary storage 130 comprises one or more electrolytic capacitors that are charged by the DC power on the common DC power bus 120 and deliver DC power to the bus during transient load conditions. The temporary storage 130 also provides power to the starter/generator 114 through the DC power bus 120 and rectifier 118 to power the starter/generator 114 during start-up of the engine 112. Alternatively, the temporary storage 130 may be provided by other known sources, such as flywheels, batteries, fuel cells, and the like.

The DC power of the common power bus 120 is delivered to a load through the DC-to-DC converter 124 and the inverter 126. The DC-to-DC converter 124 converts the DC power from the common power bus 120 into a different voltage DC output (e.g., 48 volts DC) used to supply a DC load 132. The inverter 126 converts the DC power from the common power bus 120 into an AC output, such as a reliable high voltage, three-phase AC output (e.g., 400/480 volts AC), used to supply an AC load 134. It should be understood that the AC output of the inverter 126 and the DC output of the converter 124 represent premium electric power that is substantially free of undesirable frequency variations, voltage transients, surges, dips or other disruptions.

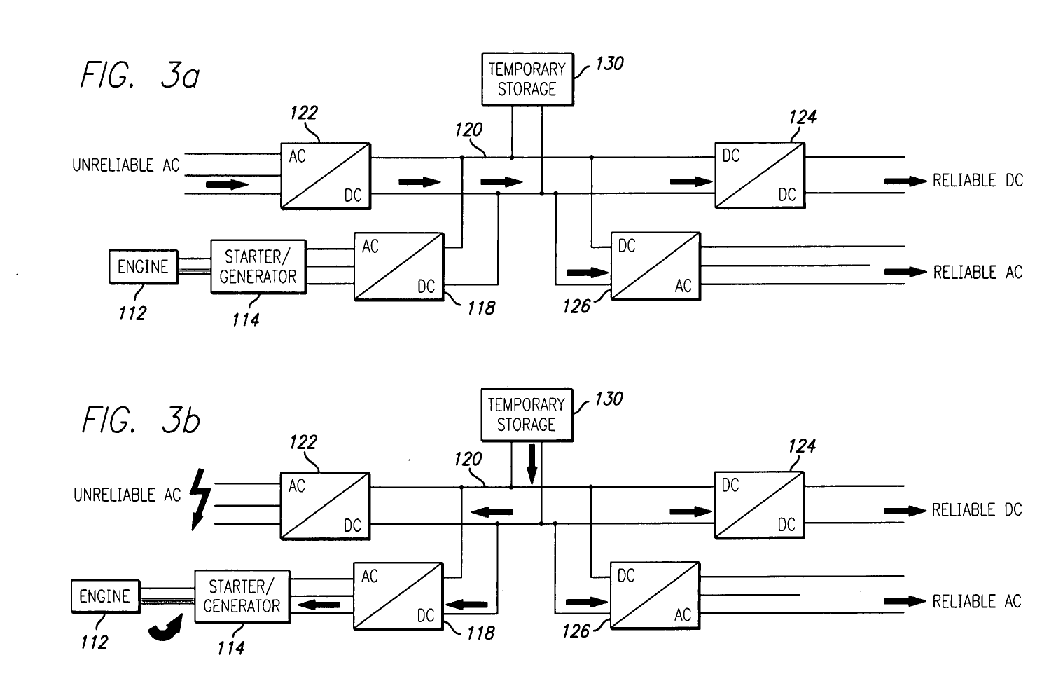

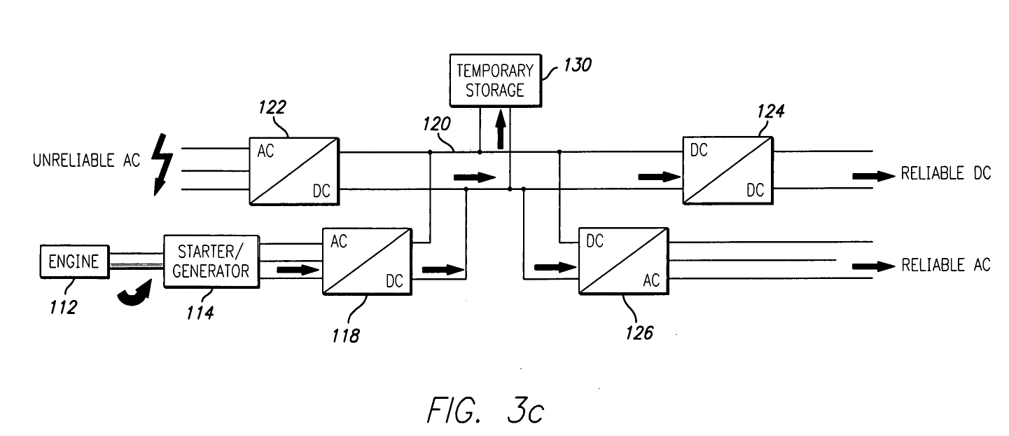

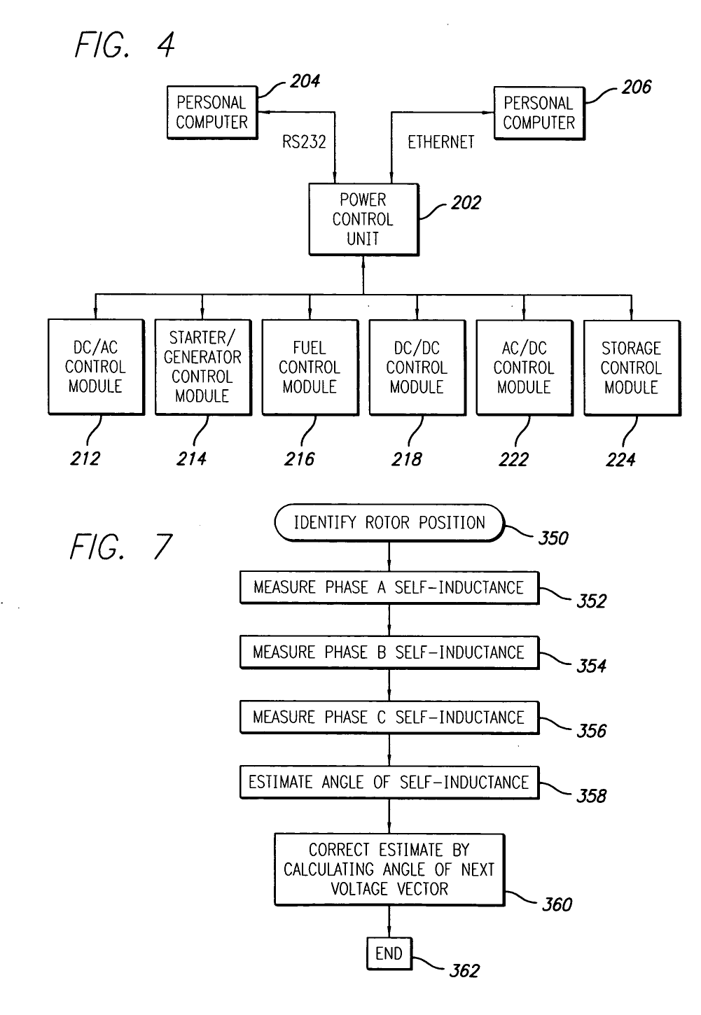

FIG. 3a illustrates normal operation of the distributed power generating system 100 with the AC mains supplying the common DC power bus 120 through rectifier 122. The temporary storage 130 is charged by the rectified DC power on the power bus 120. The DC power of the common power bus 120 is delivered to a load through the DC-to-DC converter 124 and inverter 126 as discussed above. The engine 112 and starter/generator 114 are not operating at this time.

FIG. 3b illustrates a condition of the distributed power generating system 100 in a first interval following failure of the AC mains. The temporary storage 130 provides DC power to the starter/generator 114, which commences rotating the rotor shaft of the engine 112. The temporary storage 130 also supplies power to the common DC power bus 120 for delivery to a load through the DC-to-DC converter 124 and inverter 126 as discussed above. FIG. 3c illustrates a condition of the distributed generating system 100 in a second interval following failure of the AC mains. The engine 112 has started and reached an operational speed. The direction of current in the starter/generator 114 reverses, and the starter/generator now supplies power to the common DC power bus 120 for delivery to a load through the DC-to-DC converter 124 and inverter 126 and to recharge the temporary storage 130. This condition will continue until such time as the AC mains have recovered from the fault.

It should be appreciated that the distributed power generating system must strike a balance between the size/capacity of the temporary storage 130, the power drawn by the starter/generator 114, and the start-up time of the engine 112. It is desirable to limit the size of the temporary storage 130 to the minimum necessary to supply the load and the starter/generator 114 for the time needed to bring the engine 112 up to operational speed. If the engine 112 were brought up to speed too slowly, the temporary storage 130 would have to supply the load for a longer period of time and would hence require greater size and capacity. At the same time, if the power rating of the starter/generator 114 is not properly matched to the engine 112, the starter/generator would draw excessive power from the temporary storage 130 without appreciably decreasing the time for the engine 112 to be brought to operational speed.

In the present invention, an optimal balance between these parameters is met with the starter/generator 114 selected to have a short time torque capability higher than the rated torque of the engine 112 and starter/generator 114, so that the starter/generator 114 can bring the engine 112 quickly to full operation with respect to ignition, speed and torque. The fraction of the short time torque capability of the starter/generator 114 compared to the moment of inertia of the rotating part of the engine 112 can be optimized to achieve an acceleration time from zero to rated speed within less than a second, and more particularly within less than 0.2 second. In an exemplary embodiment of the invention, the starter/generator 114 has a short time torque capability at least two times higher than the rated torque of the engine 112 and starter/generator 114. In yet another exemplary embodiment of the invention, the starter/generator 114 has a short time torque capability at least four times higher than the rated torque of the engine 112 and starter/generator 114. Due to a typically lower short time torque capability (roughly 1/10 of the rated torque of the engine 112 and starter/generator 114) and higher moment of inertia, conventional systems result in substantially longer start-up times.

Referring now to FIG. 4, an exemplary control system for the distributed power generating system is shown. The control system includes a power control unit 202 that provides central control and monitoring of various functions of the distributed power generating system. As understood in the art, the power control unit 202 may comprise general purpose or specialized circuitry such as a microprocessor, digital signal processor (DSP), application specific integrated circuit (ASIC), field programmable gate array (FPGA), discrete logic circuits, and the like, along with suitable memory for storing programming instructions and data. The power control unit 202 may be accessed by one or more personal computers 204, 206 coupled to the power control unit through conventional network system interface, such as RS232 and Ethernet. It should be further appreciated that a long distance network connection with the power control unit 202, such as via the Internet, could also be established. Using the personal computers 204, 206, a user can monitor the operation of the distributed power generating system, execute tests and measurements, be alerted to fault conditions, check fuel levels and pressures, set operating parameters, and the like.

In an embodiment of the invention, the power control unit 202 may provide an output signal constructed as a set of hypertext markup language (HTML) pages with an associated set of executable components, such as Java applets. These applets may be used, for example, to perform functions such as generating grids, charts, and tables, which appear within an HTML page when displayed by a web browser. Accordingly, the user would be able to monitor and control operation of the distributed power generation system using the web browser executing on a personal computer connected to the power control unit 202 through an associated network.

The power control unit 202 communicates with a plurality of subsystem controllers through a suitable communication bus. The communication bus may include a Controller Area Network (CAN) bus, which is a simple two-wire differential serial bus system suitable for operating in noisy electrical environments with a high level of data integrity. The CAN bus has an open architecture and a user-definable transmission medium that make the bus extremely flexible. Capable of high-speed (e.g., 1 Mbits/s) data transmission over short distances (e.g., 40 m) and low-speed (e.g., 5 kbits/s) transmissions at lengths of up to 10,000 m, the CAN bus is highly fault tolerant, with powerful error detection and handling capability. Alternatively, the communication bus may include an RS485 bus, another known standard adapted to support thirty-two drivers and thirty-two receivers bi-directionally over a single or dual twisted pair cable. An RS485 network can be connected in a two or four wire mode. Maximum cable length can be as much as 4000 feet because of the differential voltage transmission system used. It should be appreciated that the communication bus may further comprise a hybrid of these interface types, with a portion of the subsystem controllers communicating over a CAN bus and another portion communicating over an RS485 bus. Other communication bus configurations could also be advantageously utilized in the present invention.

The exemplary subsystem controllers include a DC/AC control module 212, a starter/generator control module 214, a fuel control module 216, a DC/DC control module 218, an AC/DC control module 222, and a storage control module 224. The DC/AC control module 212 is associated with the inverter 126 used to convert the DC power from the common power bus 120 into an AC output. The DC/AC control module 212 manages the operation of the inverter 126 and communicates status data to the power control unit 202, such as AC phase voltage and current, DC bus voltage measurement, operating temperature, cooling fan speed, frequency, operation time, status and errors. The power control unit 202 also communicates instructions to the DC/AC control module 212, such as to change operating parameters of the inverter 126.

The motor/generator control module 214 is associated with the starter/generator 114 used to start the engine 112 and generate power after the engine reaches operational speed. The motor/generator control module 214 manages the operation of the starter/generator 114 and communicates status data to the power control unit 202, such as DC bus voltage measurement, starter/generator speed, cooling fan speed, temperature, frequency, operation time, status and errors. The power control unit 202 also communicates instructions to the motor/generator control module 214, such as to change operating parameters of the motor/generator 114.

The fuel control module 216 is associated with the engine 112 and manages the operation of the engine 112 and the delivery of fuel to the engine. The fuel control module 216 receives as inputs various measurements from the engine, including fuel tank weight, fuel line pressure, oil level, oil pressure, oil temperature, etc., and communicates this measurement data to the power control unit 202. The power control unit 202 also communicates instructions to the fuel control module 214, such as to change throttle level, switch fuel tanks, change check valve conditions, turn on/off cooling fan, and the like.

The DC/DC control module 218 is associated with the converter 124 used to convert the DC power from the common power bus 120 into another DC level output. The DC/DC control module 218 manages the operation of the converter 124 and communicates status data to the power control unit 202, such as the DC voltage and current, operating temperature, cooling fan speed, switching frequency, operation time, status and errors. The power control unit 202 also communicates instructions to the DC/DC control module 218, such as to change operating parameters of the converter 124.

The AC/DC control module 222 is associated with the rectifier 118 used to convert the AC power from the starter/generator 114 into DC while in power generation mode, and to convert the DC voltage from the intermediate bus to AC while in engine startup mode. The AC/DC control module 222 manages the operation of the rectifier 118 and communicates status data to the power control unit 202, such as the DC voltage and current, operating temperature, switching frequency, operation time, status and errors. The power control unit 202 also communicates instructions to the AC/DC control module 222, such as to change operating parameters of the rectifier 118.

The storage control module 224 is associated with the temporary storage 130 used to supply DC power to the intermediate bus after a failure of the AC mains and before power is supplied from the starter/generator 114. The storage control module 224 manages the operation of the temporary storage 130 and communicates status data to the power control unit 202, such as the voltage of each capacitor within the temporary storage 130 and temperature.

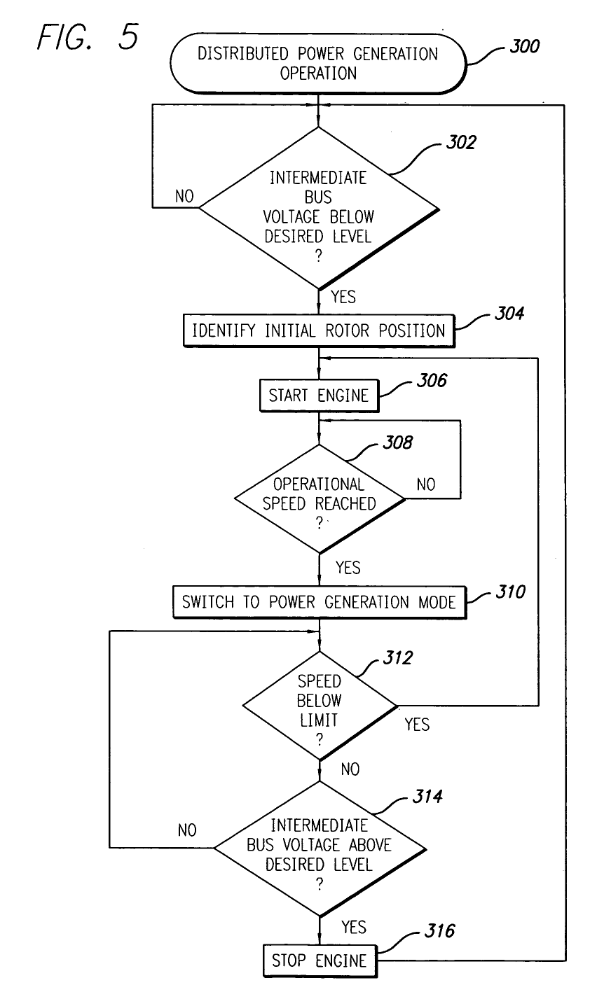

FIG. 5 illustrates a flow diagram depicting operation of the distributed power generating system under the control of the power control unit 202. The operation occurs in a continuous cycle that may be interrupted by alarms received from the various control modules indicating fault conditions of the distributed power generating system. As will be further described below, the power control unit 202 uses a measurement of the voltage on the intermediate bus as a trigger to determine when distributed power generation is needed.

In particular, at step 302, the DC voltage on the intermediate bus is compared to a desired level (e.g., 300 volts). When the AC power mains are operating properly, the DC voltage on the intermediate bus will remain at this desired level and the distributed power generation system can remain in a standby mode. But, when there is a fault of the AC power mains, the DC voltage on the intermediate bus will drop, thereby signaling the distributed power generation system to activate. Thus, if the intermediate bus voltage is equal to or greater than the desired level, the operation flow remains on step 302. Alternatively, if the intermediate bus voltage drops, the operational flow passes to step 304.

In step 304, the power control unit 202 identifies the initial position of the rotor of the starter/generator 114. As discussed above, the starter/generator 114 is used to start the engine 112 rapidly from a standstill condition. In order to achieve rapid start of the starter/generator 114, and hence the engine 112, it is desirable to know the precise position of the rotor of the starter/generator 114 relative to the corresponding stator. This way, a voltage vector can be applied to the rotor having a phase angle that will produce maximum torque on the rotor, and thereby enable the starter/generator 114 to bring the engine 112 to an operational speed as quickly as possible. An exemplary algorithm for identifying the initial position of the rotor will be described below with respect to FIG. 7.

Next, in step 306, the power control unit 202 starts the engine 112. To accomplish this, the power control unit 202 may first command the opening of check valves in the fuel delivery system to enable the delivery of fuel to the engine. An exemplary fuel delivery system for a distributed power generation system is disclosed in co-pending patent application Ser. No. ______, which is incorporated herein by reference. The power control unit 202 also provides a voltage vector to the starter/generator 114 having a phase angle corresponding to the identified initial position of the rotor. At step 308, the power control unit 202 determines whether the operational speed of the engine 112 has been reached, which is detected by signals provided by the starter/generator control module 214. As long as the operational speed is not yet reached, the power control unit 202 will continue to execute step 308. But, when the engine 112 reaches the desired operational speed, the operational flow passes to step 310.

In step 310, the power control unit 202 changes the operation of the starter/generator 114 from startup mode to power generation mode. The engine 112 is able to continue operating on its own without being driven by the starter/generator 114. The starter/generator 114 delivers AC power to the rectifier 118, which in turn provides DC power to the intermediate bus. At step 312, the power control unit 202 monitors the operation of the engine 112 to ensure that the operational speed is maintained. If the engine speed drops below a predetermined limit, possibly indicating a problem with the engine 112, the operational flow returns to step 306 and the startup sequence is repeated. Conversely, if the engine speed remains at or above the predetermined limit, the operational flow continues to step 314 in which the power control unit 202 checks the voltage of the intermediate bus. If the voltage of the intermediate bus is at or below the desired level, then the AC mains are still in a fault condition and the distributed power generation system must continue to supply back up power. The operational flow cycles through steps 312 and 314 again. Conversely, if the voltage of the intermediate bus is above the desired level, then the fault condition of the AC mains has cleared and it is no longer necessary for the distributed power generation system to supply back up power. The operational flow then passes to step 316 in which the engine 112 is shut down. This step may also include the closing of check valves in the fuel delivery system to cut off the delivery of fuel to the engine 112. The operational flow then returns to step 302, and the entire process repeats.

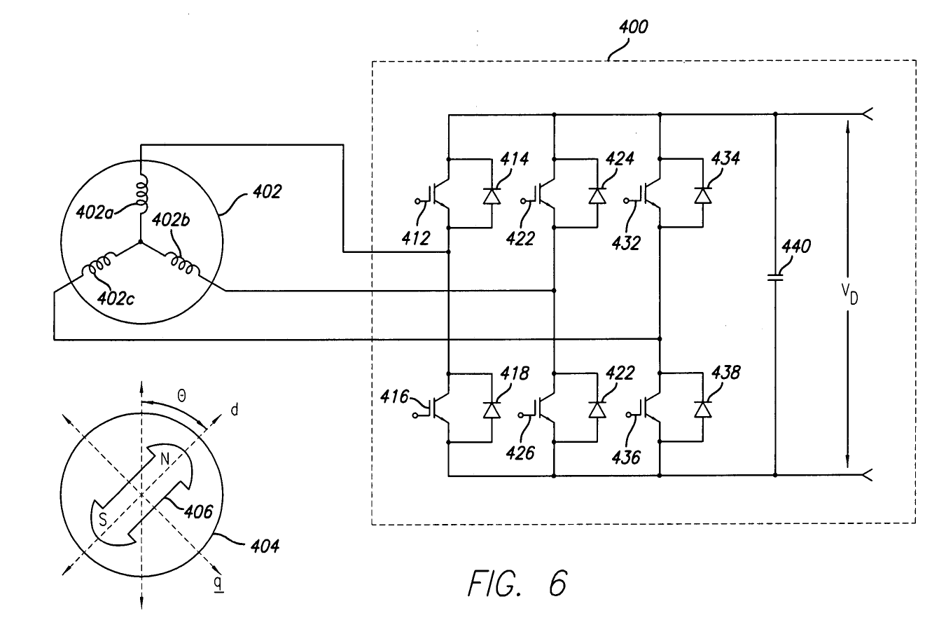

Referring now to FIGS. 6 and 7, the identification of the initial rotor position will now be described. The starter/generator 114 comprises a magnetic rotor 404 having a plurality of permanent magnets (depicted by magnetic polepiece 406) and a stator 402 having three-phase windings 402a, 402b, and 402c arranged radially separated at equal intervals by 120°. It should be understood that the rotor 404 would rotate around a common axis shared by the stator 402. In the startup mode, the rotor is caused to rotate by applying a three-phase AC voltage from the rectifier 118 to the stator windings to produce a rotating magnetic field. Conversely, in the generator mode, the rotor is caused to rotate by operation of the engine 112, thereby inducing a three-phase AC voltage on the stator windings. The AC voltage is full-wave rectified to a direct current by the rectifier 118 to supply a DC voltage to the intermediate bus.

More particularly, the rectifier includes a driving circuit 400 shown in FIG. 6 as comprising a plurality of semiconductor rectifying devices connected in a bridge form. The driving circuit 400 includes three serially-coupled pairs of transistors connected in parallel between respective input terminals. More particularly, stator winding 402a is connected to the junction between the emitter terminal of transistor 412 and the collector terminal of transistor 416, stator winding 402b is connected to the junction between the emitter terminal of transistor 422 and the collector terminal of transistor 426, and stator winding 402c is connected to the junction between the emitter terminal of transistor 432 and the collector terminal of transistor 436. Diodes 414, 425, 434, 418, 428, 438 are coupled between the emitter and collector of respective transistors 412, 422, 432, 416, 426, 436. A capacitor 440 provides smoothing of a DC driving voltage applied (V_{D}) from the intermediate bus to the input terminals coupled across the transistor pairs. Driving signals applied to the base terminals of the transistors selectively activate the transistors to provide a three-phase AC voltage to the stator windings to thereby produce the rotating magnetic field.

As discussed above, if the initial angular position of the rotor 404 relative to the stator 402 is known, then initial driving signals can be applied to the driving circuit 400 that matches the angular position and thereby applies maximum torque on the rotor. In a permanent magnet synchronous in which the magnets are mounted inside the rotor, the variation in the self-inductance is sinusoidal and the frequency of the variation is twice the motor frequency. Since the self-inductance varies with the rotor angular position, knowledge of the inductance can therefore be used to determine the rotor angular position. And, since the variation in inductance from motor to motor can be significant, it is preferred to measure the inductance in all three motor phases and derive the average inductance from the measurement. Ignoring the effect of the stator resistance (rₛ) (which is small), and assuming that the time it takes to perform the inductance measurement is much shorter than the mechanical time constant given by the moment of inertia of the rotor, the voltage (Vₛ) across the stator winding as a function of time (t) and current (I) is defined by the following expression:

$${V}_{s} = L \frac{ⅆ I}{ⅆ t}$$

The magnitude of the voltage vector that is applied to the stator windings is equal to the driving voltage (V_{D}). Accordingly, the self-inductance can be determined by the following expression:

$$L = \frac{{V}_{D}}{Δ I} \cdot Δ t$$

wherein ΔI is the change in current over the time Δt. The driving signals applied to the driving circuit 400 can define a phase angle of the voltage vector as 0°, 60°, 120°, 180°, 240°, 300°, or 360°, depending upon which transistor of the driving circuit is activated.

FIG. 7 illustrates a flow diagram depicting an algorithm 350 for identifying the initial angular position of the rotor of the starter/generator. Starting at step 352, the self-inductance of phase A (winding 402a) is measured. This step is performed by first activating transistors 412, 426, and 436. When the current in phase A reaches a positive selected level, transistors 412, 426, and 436 are deactivated and transistors 416, 422, 432 are activated. In a preferred embodiment of the invention, the selected current level (positive or negative) corresponds to three times the nominal current through the winding (or per units (pu)). The time (Δtₐ) is measured for the current in phase A to fall from the positive selected level (e.g., 3 pu) to a negative selected level (e.g., −3 pu). Since the self-inductance variation is very small, the present invention uses a higher than nominal current to measure the self-inductance in order to achieve a higher signal-to-noise ratio. It should be appreciated that the selected current level (positive or negative) is limited by the maximum allowable current limit of the transistors of the driving circuit 400.

Next, at step 354, the self-inductance of phase B (winding 402b) is measured. This step is performed by first activating transistors 416, 422, and 436. When the current in phase B reaches a positive selected level, transistors 416, 422, and 436 are deactivated and transistors 412, 426, 432 are activated. The time (Δt_{b}) is measured for the current in phase B to fall from the positive selected level (e.g., 3 pu) to a negative selected level (e.g., −3 pu). Then, at step 356, the self-inductance of phase C (winding 402c) is measured. This step is performed by first activating transistors 416, 426, and 432. When the current in phase C reaches a positive selected level, transistors 416, 426, and 432 are deactivated and transistors 412, 422, 436 are activated. The time (Δt_{c}) is measured for the current in phase C to fall from the positive selected level (e.g., 3 pu) to a negative selected level (e.g., −3 pu).

At step 358, an initial estimate of the phase angle of the self-inductance (2θ) is calculated, using the following expression:

$$2 θ = - {tan}^{- 1} ( \frac{\frac{\sqrt{3}}{2} Δ {t}_{b} - \frac{\sqrt{3}}{2} Δ {t}_{c}}{Δ {t}_{a} - \frac{1}{2} Δ {t}_{b} - \frac{1}{2} Δ {t}_{c}} )$$

Since the frequency of the variation in the self-inductance is two times the motor frequency, the initial estimate of the rotor angle is θ. This initial estimate may be correct or it may be incorrect (i.e., out of phase) by 180°.

Accordingly, at step 360, the initial estimate of the self-inductance is tested by calculating the phase angle of the next voltage vector in order to determine whether the initial estimate is correct. In this step, the phase angle of the next voltage vector is used to find the position of the rotor's d-axis. In an induction motor, the direct, or d-axis, current component flows through the parallel inductor, and the quadrature, or q-axis, current component flows through the parallel resistor (see FIG. 6). The d-axis component produces rotor flux; the q-axis component produces torque. A positive current vector in the same direction as the d-axis will increase the flux density in the stator, resulting in higher saturation and a lower inductance as compared to a negative current vector.

More particularly, this test step 360 is similar to the measurements of self-inductance performed in the preceding steps. A voltage vector is applied to the stator having the estimated phase angle calculated in step 358, i.e., by activating/deactivating appropriate ones of the transistors of the driving circuit 300. Since it is not practical to apply the exact phase angle of the voltage vector (such as 57°), the closest approximation of the phase angle (such as 60°) is applied. First, the time is measured for the current to fall from a positive selected level (e.g., 3.5 pu) to zero. Then, the activated transistors are deactivated and the deactivated transistors are activated, and the time is measured for the current to rise from a negative selected level (e.g., −3.5 pu) to zero. The rate of change of the current reflects whether the estimation of the phase angle is correct or off by 180°. Specifically, if the current falls more quickly from the positive selected level to zero than it rises from the negative selected level to zero, then the estimated phase angle was correct. Conversely, if the current rises from the negative selected level to zero more quickly than it falls from the positive selected level to zero, then the estimated phase angle was not correct and should be shifted by 180°. Following confirmation of the estimated phase angle, the algorithm ends at step 362.

Having thus described a preferred embodiment of the control system for a distributed power generating system, it should be apparent to those skilled in the art that certain advantages of the within system have been achieved. It should also be appreciated that various modifications, adaptations, and alternative embodiments thereof may be made within the scope and spirit of the present invention. The invention is further defined by the following claims.

What is claimed is:

1. A distributed power generating system, comprising:
a power bus electrically coupled to commercial power and to a load;
an engine comprising a rotatable shaft;
a starter/generator operatively coupled to the shaft of the engine and electrically coupled to said power bus, the starter/generator having a short time torque capability higher than the rated torque of the engine and starter/generator;
a temporary storage device electrically coupled to said power bus; and
a control system adapted to detect a failure of the commercial power and cause the starter/generator to start the engine from a standstill condition with an initial voltage vector selected to rapidly bring the engine to an operational speed sustainable by the engine alone, said temporary storage device supplying electrical power to said power bus for delivery to said load and for powering said starter/generator until said engine reaches the operational speed, whereupon said control system causes said starter/generator to take over supply of electrical power to said power bus for delivery to said load.

2. The distributed power generating system of claim 1, wherein the starter/generator further comprises a rotor and a stator, the stator including a plurality of phase windings, the control system identifying an initial position of said rotor relative to said stator and selecting said voltage vector to provide maximum torque to said rotor.

3. The distributed power generating system of claim 2, wherein the control system measures self-inductance of each said phase winding of said stator.

4. The distributed power generating system of claim 3, wherein the control system estimates an angle of self-inductance of said stator based on said self-inductance inductance of each said phase winding.

5. The distributed power generating system of claim 4, wherein the control system estimates said angle of self-inductance of said stator in accordance with the following equation:
$$2 θ = - {tan}^{- 1} ( \frac{\frac{\sqrt{3}}{2} Δ {t}_{b} - \frac{\sqrt{3}}{2} Δ {t}_{c}}{Δ {t}_{a} - \frac{1}{2} Δ {t}_{b} - \frac{1}{2} Δ {t}_{c}} )$$
wherein, θ is the estimated angle of self-inductance of said stator, Δtₐ is the time for current in phase A of said stator to fall from a positive selected level to a negative selected level, Δt_{b} is the time for current in phase B of said stator to fall from said positive selected level to said negative selected level, and Δt_{c}, is the time for current in phase C of said stator to fall from said positive selected level to said negative selected level.

6. The distributed power generating system of claim 4, wherein the control system corrects the estimated angle of self-inductance of said stator.

7. The distributed power generating system of claim 1, wherein the control system starts the engine upon detection of a voltage on said power bus below a predetermined lower limit.

8. The distributed power generating system of claim 1, wherein the control system monitors speed of said engine to determine whether said operational speed is reached.

9. The distributed power generating system of claim 1, wherein the control system terminates operation of said engine upon detection of a voltage on said power bus above a predetermined upper limit.

10. The distributed power generating system of claim 1, wherein the temporary energy storage device further comprises at least one capacitor.

11. The distributed power generating system of claim 1, wherein said engine reaches the operational speed in less than one second.

12. The distributed power generating system of claim 1, wherein said engine reaches the operational speed in less than 0.2 second.

13. A method for distributing power to a load coupled to a power bus, comprising:
supplying commercial power to said load over said power bus;
detecting a fault of said commercial power, and in the event of a fault:
supplying stored power to said load and to a starter/generator operatively coupled to an engine, the starter/generator having a short time torque capability higher than the rated torque of the engine and starter/generator;
starting the engine from a standstill condition by applying an initial voltage vector selected to rapidly bring the engine to an operational speed sustainable by the engine alone; and
supplying generated power to said load from said starter/generator after said engine reaches said operational speed.

14. The method of claim 13, wherein the starter/generator further comprises a rotor and a stator, the stator including a plurality of phase windings, the step of starting the engine further comprises identifying an initial position of said rotor relative to said stator and selecting said initial voltage vector to provide maximum torque to said rotor.

15. The method of claim 14, wherein the step of identifying an initial position further comprises measuring self-inductance of each said phase winding of said stator.

16. The method of claim 15, wherein the step of identifying an initial position further comprises estimating an angle of self-inductance of said stator based on said self-inductance of each said phase winding.

17. The method of claim 16, wherein the step of estimating said angle of self-inductance of said stator is performed in accordance with the following equation:
$$2 θ = - {tan}^{- 1} ( \frac{\frac{\sqrt{3}}{2} Δ {t}_{b} - \frac{\sqrt{3}}{2} Δ {t}_{c}}{Δ {t}_{a} - \frac{1}{2} Δ {t}_{b} - \frac{1}{2} Δ {t}_{c}} )$$
wherein, θ is the estimated angle of self-inductance of said stator, Δtₐ is the time for current in phase A of said stator to fall from a positive selected level to a negative selected level, Δt_{b} is the time for current in phase B of said stator to fall from said positive selected level to said negative selected level, and Δt_{c} is the time for current in phase C of said stator to fall from said positive selected level to said negative selected level.

18. The method of claim 16, wherein the step of estimating said angle of self-inductance further comprises correcting the estimated angle of self-inductance.

19. The method of claim 13, wherein the step of detecting a fault of said commercial power further comprises detecting a voltage on said power bus below a predetermined lower limit.

20. The method of claim 13, wherein the step of starting said engine further comprises monitoring speed of said engine to determine whether said operational speed is reached.

21. The method of claim 13, further comprising terminating operation of said engine upon detection of a voltage on said power bus above a predetermined upper limit.
